(19) United States
(12) Patent Application Publication
(10) Pub. No.: US 2013/0138381 A1
(43) Pub. Date: May 30, 2013

(54) HANDHELD ELECTRONIC DEVICE TESTING METHOD

(71) Applicants: FENG-JUNG LEE, TAIPEI CITY (TW); CHING-FENG HSIEH, TAIPEI CITY (TW)

(72) Inventors: FENG-JUNG LEE, TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/343,887

(22) Filed: Jan. 5, 2012

(30) Foreign Application Priority Data
Nov. 25, 2011 (TW) 100143303

(51) Int. Cl. G06F 19/00

(52) U.S. Cl. 702/123

(57) ABSTRACT

A testing method tests a handheld electronic device installed with an open operating platform and having a touchscreen. The testing method includes the steps of executing a screen test program installed on the open operating platform to start a testing procedure; generating test coordinates by the screen test program; performing a touch selection operation based on the test coordinates by the touchscreen; and performing a functional operation by the open operating platform in response to the touch selection operation. The testing loop is repeatedly executed to simulate the ways a user may exercise touch control over the handheld electronic device to cause the handheld electronic device to hang or cause damage to software programs thereof. Accordingly, the testing method enhances the reliability of testing the handheld electronic device.

### CROSS-REFERENCE TO RELATED APPLICATION

This non-provisional application claims priority under 35 U.S.C. §119(a) on Patent Application No(s). 100143303 filed in Taiwan, R.O.C. on Nov. 25, 2011, the entire contents of which are hereby incorporated by reference.

### FIELD OF TECHNOLOGY

The present invention relates to handheld electronic device testing methods, and more particularly, to a testing method for testing a handheld electronic device having a touchscreen whereby a touch control operation is performed to carry out the testing method.

### BACKGROUND

Due to the prevalence of handheld electronic devices, such as smartphones and tablet computers, a wide variety of handheld electronic devices are commercially available. Another feature of the handheld electronic devices, such as smartphones and tablet computers, is that each of them has a touchscreen.

Although the touchscreen enables a user to operate the handheld electronic device conveniently, it is possible for the user to touch the touchscreen inadvertently or touch the touchscreen twice or more in a specific sequence to cause the handheld electronic device to hang or cause damage to software programs thereof. The aforesaid problems should be discovered and solved in the design stage of the handheld electronic device or an application installed thereon.

However, conventional testing methods do not include one whereby a simulation test is performed on a handheld electronic device and designed to simulate a user's touch on the handheld electronic device. As a result, it is not until the handheld electronic device has been launched into the market that the users discover plenty drawbacks of the handheld electronic device and thereby motivate the manufacturer of the handheld electronic device to take remedial measures, thereby resulting in a great economic loss.

### SUMMARY

It is an objective of the present invention to provide a testing method for testing a handheld electronic device in a manner that is labor-saving, cost-saving, and conducive to discovery of problems.

Another objective of the present invention is to discover random-related problems not confronted with a test performed by hand and enhance the probability of reproducing the random-related problems.

Yet another objective of the present invention is to enhance the reliability of a test. In order to achieve the above and other objectives, the present invention provides a testing method for testing a handheld electronic device, applicable to testing a handheld electronic device installed with an open operating platform and equipped with a touchscreen, the testing method comprising the steps of: executing a screen test program installed on the open operating platform to start a testing procedure; generating test coordinates whereby the open operating platform generates a touch control operation execution command and sends the touch control operation execution command and the test coordinates to the touchscreen; performing a touch selection operation on the touchscreen corresponding to the test coordinates in response to the touch control operation execution command; performing a functional operation by the open operating platform in response to the touch selection operation; and going back to the step of generating test coordinates so as to generate next test coordinates after the open operating platform has finished performing the functional operation successfully.

In an embodiment, the test method further comprises the step of stopping the testing procedure after the open operating platform has failed to perform the functional operation, and the test method further comprises the step of recording a total time from commencement of the testing procedure to termination of the testing procedure after the aforesaid testing procedure stopping step.

In an embodiment, the test coordinates are randomly generated by the screen test program.

In an embodiment, the test coordinates randomly generated by the screen test program are single coordinates or complex coordinates.

In an embodiment, in the step of generating test coordinates, linear reciprocating test coordinates are sequentially generated in accordance with a test of each loop to simulate a linear reciprocating touch operation on the touchscreen.

In an embodiment, in the step of generating test coordinates, rotational cyclic test coordinates are sequentially generated in accordance with a test of each loop to simulate a rotational reciprocating touch operation on the touchscreen.

In an embodiment, testing method further comprises the step of the step of stopping the testing procedure as soon as a total time of the testing procedure reaches a specific number of hours.

In an embodiment, the open operating platform is an Android operating platform.

Accordingly, the testing method of the present invention simulates a touch sequence in which a user touches a touchscreen randomly or inadvertently in daily life or even simulates the user's single-point touch and multipoint touch, such that any insidious defect of a handheld electronic device can be discovered by the aforesaid pressure test. The test can be quantified and analyzed so as to the reliability of a test performed on the handheld electronic device.

### BRIEF DESCRIPTION

Objectives, features, and advantages of the present invention are hereunder illustrated with specific embodiments in conjunction with the accompanying drawings, in which:

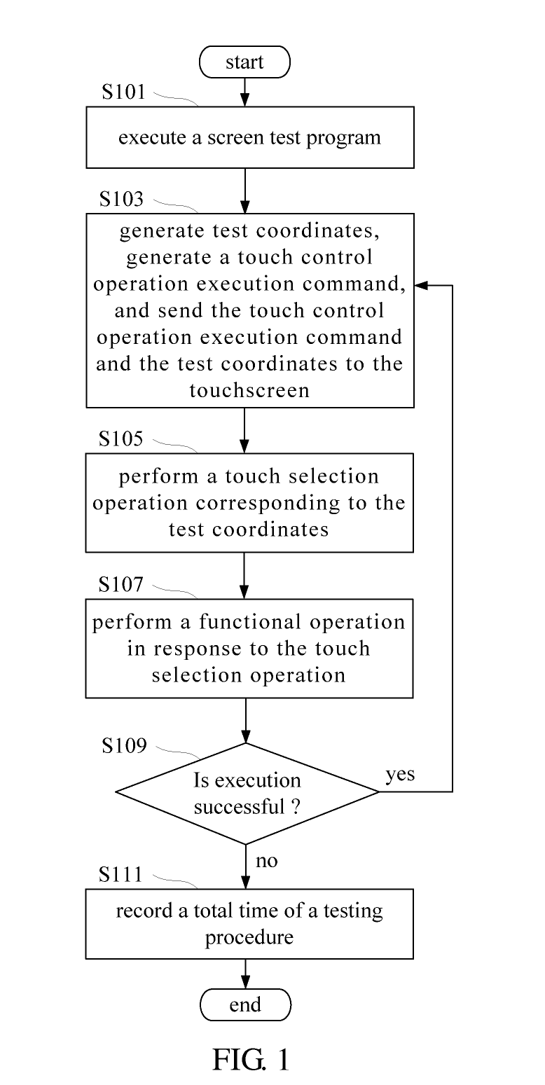

FIG. 1 is a flow chart of a testing method for use with a handheld electronic device according to an embodiment of the present invention; and

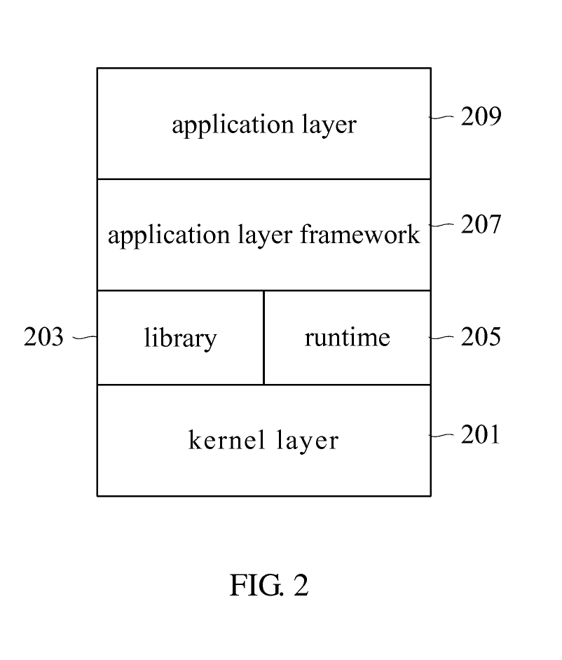

FIG. 2 is a schematic view of functional layers of an Android operating platform.

### DETAILED DESCRIPTION

Referring to FIG. 1, there is shown a flow chart of a testing method for use with a handheld electronic device according to an embodiment of the present invention. The testing method is for testing a handheld electronic device installed with an open operating platform and equipped with a touchscreen.

First, step S101 involves executing a screen test program installed on the open operating platform to start a testing procedure. The screen test program is installed on the open operating platform in advance to facilitate performing a subsequent testing procedure.

Then, step S103 involves generating test coordinates by the screen test program after the screen test program has been executed and before the testing procedure starts, such that the open operating platform generates a touch control operation execution command and sends the touch control operation execution command and the test coordinates to the touchscreen.

In step S103, the test coordinates are for specifying touch point coordinates on the touchscreen for simulating the position touched by the user. The sequence of the test coordinates generated is configured as needed or generated randomly by the screen test program. A test of a specific sequence can simulate a possible way of the user's touching the touchscreen in a specific state, such as touching the touchscreen in a linear reciprocating manner or in a rotational reciprocating manner. The user's casual touch can be reproduced by randomly generated touch coordinates. In a protective state characterized in that the screen lock is off, the user is likely to touch the touchscreen casually and unwittingly, whether in a single-point manner or a multipoint manner, thereby causing the handheld electronic device to hang or causing damage to software installed on the handheld electronic device. Hence, the present invention increases the probability of discovering problems by means of touch control of a specific sequence or touch point coordinates touch. The touch point coordinates touch is effective in discovering random-related problems not confronted with a test performed by hand and enhancing the probability of reproducing the random-related problems.

In step S103, the screen test program enables the open operating platform to generate a touch control operation execution command, and then the open operating platform sends the touch control operation execution command and the test coordinates to the touchscreen, such that a driver of the touchscreen performs a subsequent test step based on the touch control operation execution command and the test coordinates.

In step S105, the driver of the touchscreen performs a touch selection operation corresponding to the test coordinates on the touchscreen in response to the touch control operation execution command.

In step S107, the open operating platform performs a functional operation in response to the touch selection operation. This step simulates a program to be executed by the open operating platform after the user has touched the test coordinates (if the user touches program ICON or any other executable items displayed on the screen). It is possible for the test coordinates to refer to the situation where a position of an executable function operation is absent from the touchscreen; meanwhile, the result of the touch is successful, as far as the screen test program is concerned, because touching the position does not cause the handheld electronic device to hang or cause damage to an application installed thereon.

Finally, step S109 involves going back to the step of generating test coordinates (S103) so as to generate next test coordinates after the open operating platform has successfully finished performing the functional operation at the position of a simulated touch, and then performing a loop-style pressure test (not shown). It is also feasible for the user to configure the testing procedure in a manner that the loop-style pressure test (not shown) stops as soon as the total time of the testing procedure reaches a specific number of hours, such as 25 hours, and in consequence it is feasible to confirm whether the handheld electronic device is stable and evaluate the reliability of the testing method accurately.

In step S109, the testing procedure stops as soon as the open operating platform fails to perform the functional operation corresponding to the position of a simulated touch.

In an embodiment of the present invention, the testing method further comprises the step (S111) of recording a total time from commencement of the testing procedure to termination of the testing procedure after the step of stopping the testing procedure (S109). A failure of execution means that the handheld electronic device has a chance of being unstable and the chance of being unstable has been discovered by the testing method of the present invention. A developer should make reference to the time taken for a failure to occur from the commencement of the loop-style pressure test, and what program or step has been performed prior to the failure, such that the developer can make improvement in the handheld electronic device.

In another embodiment of the present invention, the testing method is applied to a handheld electronic device installed with an Android operating platform. FIG. 2 is a schematic view of functional layers of an Android operating platform. The Android operating platform comprises a kernel layer 201, a library 203, a runtime 205, an application layer framework 207, and an application layer 209. Since the Android operating platform is published technology, the details of the operation of its functional layers are not described hereunder for the sake of brevity. In an embodiment of the present invention, the screen test program is installed on the application layer 209, such that the Android operating platform performs the steps of: simulating events of touching specific coordinates on the screen by means of the application layer framework 207, the library 203, and the runtime 205; sending the touch control operation execution command and the test coordinates to a screen driver in the kernel layer 201; performing the selected functional operation; and feeding back the operation to the application layer to enable the screen test program to determine and record the result of execution for serving as the basis of determining whether to begin the next test loop.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A testing method for testing a handheld electronic device, applicable to testing a handheld electronic device installed with an open operating platform and equipped with a touchscreen, the testing method comprising the steps of:
executing a screen test program installed on the open operating platform to start a testing procedure;
generating test coordinates whereby the open operating platform generates a touch control operation execution command and sends the touch control operation execution command and the test coordinates to the touchscreen;
performing a touch selection operation on the touchscreen corresponding to the test coordinates in response to the touch control operation execution command;
performing a functional operation by the open operating platform in response to the touch selection operation; and
going back to the step of generating test coordinates so as to generate next test coordinates after the open operating platform has finished performing the functional operation successfully.

2. The testing method of claim 1, further comprising the step of stopping the testing procedure after the open operating platform has failed to perform the functional operation.

3. The testing method of claim 2, further comprising the step of recording a total time from commencement of the testing procedure to termination of the testing procedure after the step of stopping the testing procedure after the open operating platform has failed to perform the functional operation.

4. The testing method of claim 1, wherein the test coordinates are randomly generated by the screen test program.

5. The testing method of claim 1, wherein the test coordinates randomly generated by the screen test program are single coordinates or complex coordinates.

6. The testing method of claim 1, wherein, in the step of generating test coordinates, linear reciprocating test coordinates are sequentially generated in accordance with a test of each loop to simulate a linear reciprocating touch operation on the touchscreen.

7. The testing method of claim 1, wherein, in the step of generating test coordinates, rotational cyclic test coordinates are sequentially generated in accordance with a test of each loop to simulate a rotational reciprocating touch operation on the touchscreen.

8. The testing method of claim 1, further comprising the step of stopping the testing procedure as soon as a total time of the testing procedure reaches a specific number of hours.

9. The testing method of claim 1, wherein the open operating platform is an Android operating platform.
